(19) United States
(12) Patent Application Publication
(10) Pub. No.: US 2026/0118825 A1
(43) Pub. Date: Apr. 30, 2026

(54) WATCH COMPRISING A HOROLOGY MOVEMENT COMPRISING A DEVICE FOR DISPLAYING AN EARTH PHASE

(71) Applicant: ETA SA Manufacture Horlogère Suisse, Grenchen (CH)

(72) Inventors: Gregory Kissling, La Neuveville (CH); Adrien Keller, Neuchâtel (CH)

(73) Assignee: ETA SA Manufacture Horlogère Suisse, Grenchen (CH)

(21) Appl. No.: 19/350,100

(22) Filed: Oct. 6, 2025

(30) Foreign Application Priority Data
Oct. 30, 2024 (EP) 24209952.1

(51) Int. Cl. G04B 19/26

(52) U.S. Cl. CPC G04B 19/26

(57) ABSTRACT

A watch (10) including a dial (13) and a horology movement (11) including a device for displaying the Earth, the watch (10) being characterised in that the device for displaying Earth phases (12) includes a display (120) having two diametrically opposite graphical representations of the Earth (121) on either side of an axis of rotation of the display (120), the display (120) being arranged facing an aperture (130) made in the dial (13) and having a shape such that it is capable of masking one of the graphical representations of the Earth (121) when the display (120) is rotated; the Earth phase display device (12) has a mask (122) rotated by a drive organ (14) and inserted between the display (120), the display (120) and the mask (122) being driven at different rotational velocities.

### CROSS REFERENCE TO RELATED APPLICATIONS

This application claims priority to European Patent Application No. 24209952.1 filed Oct. 30, 2024, the entire contents of which are incorporated herein by reference.

### TECHNICAL FIELD OF THE INVENTION

The invention relates to the field of horology and in particular to devices for displaying a time value on a timepiece.

More specifically, the invention relates to a device for displaying an Earth phase for the horology movement in a watch. The display device is capable of indicating which part of the Earth is visible from the Moon, and in particular of indicating the phases of the Earth as they would be perceived by an observer from the Moon.

### TECHNOLOGICAL BACKGROUND

In the field of horology, particularly with regard to horological complications, it may be desirable to offer unexpected or commemorative displays so that the aesthetic appearance of the watch is particularly distinctive and attractive. Visual animation is one of the many solutions provided.

Moon phase displays are quite common in the field of horology, as are Earth phase displays, in other words, displays of the part of the Earth visible from the Moon.

Moon or Earth phase display devices considerably complicate the horology movement into which they are incorporated.

The invention meets the need to display an attractive Earth phase.

### SUMMARY OF THE INVENTION

The present invention aims to enable the Earth phase and the part of the Earth's surface that can be seen by an observer orbiting the Moon to be indicated simultaneously in a single dial aperture.

To this end, the invention relates to a watch comprising a dial and a horology movement comprising an Earth phase display device. The Earth phase display device comprises a display showing two diametrically opposite graphical representations of the Earth on either side of an axis of rotation of the display. The display is arranged facing an aperture made in the dial and having a shape such that it is capable of masking one of the graphical representations of the Earth when the display is rotated. The Earth phase display device further comprises a mask rotated by a drive organ and inserted between the display, the display and the mask being driven at different rotational velocities. Preferentially, the mask is driven at a higher velocity than that of the display.

In particular embodiments, the invention can further comprise one or more of the following features, taken separately or in any technically possible combination.

In particular embodiments, the axis of rotation of the display and that of the mask are coincident.

In particular embodiments, the mask has an opaque zone, in which part of the periphery forms two lobes in the form of a circular arc, arranged diametrically symmetrical to each other. The opaque zone is designed to partially or completely cover, and therefore mask, the graphical representation of the Earth when the mask is rotated.

In particular embodiments, the transparent and opaque zones are arranged diametrically opposite each other, so that when the mask is in a first angular position, most of the transparent zone or all of said transparent zone is arranged facing the aperture, and that when the mask is in a second angular position in which the mask is oriented at 180 degrees relative to the first angular position, the opaque zone is facing the entire aperture.

In particular embodiments, the mask is fastened to a pivot shank on a drive mobile so as to rotate along with it via a mask pipe, the drive mobile comprising a drive wheel by which it is driven by the drive organ. The display is fastened to the pivot shank so as to be rotationally mobile via a display pipe, the display pipe comprising a display pipe wheel by which it is connected to a pinion on the drive mechanism via an intermediate wheel.

In particular embodiments, the mask and the display are rotated by the same drive organ formed by an electric motor designed to be powered with energy from a source of electricity.

In particular embodiments, the mask and the display are moved by the same drive organ formed by a barrel kinematically connected to a regulating organ.

### BRIEF DESCRIPTION OF THE FIGURES

Other features and advantages of the invention will become apparent from the following detailed description, given by way of non-limiting example, with reference to the attached drawings in which:

FIG. 1 shows a front view of a watch comprising a device for displaying an Earth phase according to a preferred exemplary embodiment of the invention,

FIG. 2 shows an exploded perspective view of certain components of the watch in FIG. 1, and a close-up view of the device for displaying an Earth phase,

FIG. 3 shows a cross-sectional view along an axis A-A of the watch in FIG. 1.

It should be noted that the figures are not necessarily drawn to scale for clarity reasons.

### DETAILED DESCRIPTION OF THE INVENTION

The present invention relates to a watch 10 comprising a horology movement 11 comprising an Earth phase display device 12.

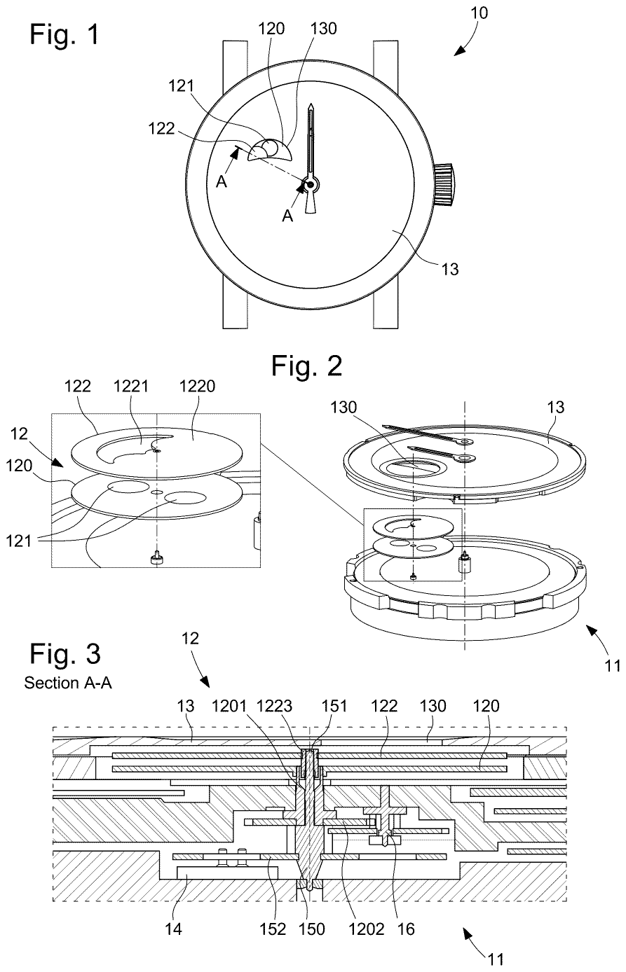

The watch 10 is provided with a dial 13 in which an aperture 130 is made through which an Earth phase is designed to appear, as can be seen in the front view in FIG. 1.

The Earth phase display device 12 comprises a display 120 showing two diametrically opposite graphical representations of the Earth 121 on either side of an axis of rotation of the display 120. More specifically, the display 120 is arranged so as to be rotationally mobile relative to the dial 13 and facing the aperture 130. Advantageously, each of the graphical representations of the Earth 121 can represent complementary terrestrial hemispheres, for example the Eastern hemisphere and the Western hemisphere.

In the exemplary embodiment of the invention shown in the figures, the display 120 is in the form of a disc and the aperture 130 is substantially semi-circular in shape, such that the dial 13 consists of a mask behind which part of the display 120 can be concealed when it is rotated.

The Earth phase display device 12 further comprises a mask 122 inserted between the display 120 and the dial 13, and arranged so as to be rotationally mobile relative to the display 120 and relative to the dial 13 so as to be able to alternately conceal and reveal one of the graphical representations of the Earth 121. As shown in FIGS. 2 and 3, the axis of rotation of the display 120 and that of the mask 122 are coaxial.

Preferentially, the graphical representation of the Earth 121 is produced on a back, the appearance of which is identical to that of the mask 122. For example, the back and the mask 122 have an identical solid colour.

In the preferred exemplary embodiment of the invention, and as shown in FIG. 2, the mask 122 comprises an opaque zone 1220, in which part of the periphery forms two lobes in the shape of a circular arc arranged diametrically symmetrical to each other. The opaque zone 1220 is designed to partially or completely cover and therefore mask the graphical representation of the Earth 121 as the mask 122 rotates, as can be seen in FIG. 1.

Moreover, the mask 122 also comprises a transparent zone 1221, for example formed by a through opening or by a transparent material, through which the display 120 is designed to be visible when the mask 122 is rotated. As shown in the close-up view in FIG. 2, the part of the periphery of the opaque zone 1220 forming the lobes is adjacent to the transparent zone 1221.

The transparent zone 1221 and the opaque zone 1220 are arranged diametrically opposite each other, so that when the mask 122 is in a first angular position, most of the transparent zone 1221 or all of the transparent zone 1221 is arranged facing the aperture 130, and so that when the mask 122 is in a second angular position, the opaque zone 1220 is facing the entire aperture 130. In its second angular position, the mask 122 is oriented at 180 degrees relative to its first angular position.

To sum up, as can be seen in FIG. 1, as one of the lobes moves facing the aperture 130, it can partially or completely cover the graphical representation of the Earth 121. As it rotates, the mask 122 therefore causes a variation in the visible surface of the graphical representation of the Earth 121, and more specifically by alternately increasing and reducing this visible surface. In other words, the graphical representation of the Earth 121 appearing through the aperture 130 is gradually concealed and revealed by the mask 122.

To sum up, rotating the display 120 displays the part of the Earth visible from the Moon and rotating the mask 122 relative to the display 120 displays the Earth phase, i.e., the part of the Earth illuminated by the Sun.

The present invention thus makes it possible, by rotating both the mask 122 and the display 120 at different rotational velocities, to represent the view of an observer orbiting the Moon and facing the Earth. As a result, the watch 10 features a particularly attractive astronomical animation.

In particular, in the preferred exemplary embodiment of the invention, the mask 122 is rotated at a higher velocity than the display 120.

The display 120 and the mask 122 are rotated by a drive organ 14 formed, in the exemplary embodiment of the invention shown in the figures, by an electric motor which can be seen in particular in the cross-sectional view in FIG. 3. The electric motor is designed to be powered with energy from a source of electricity, preferentially consisting of an electric cell or accumulator connected to a solar cell.

In a preferred exemplary embodiment, as can be seen in FIG. 3, the mask 122 can be fastened to a mask pipe 1223, so as to be rotationally immobile, itself rotating along with a pivot shank 151 on a drive mobile 150. The drive mobile 150 comprises a drive wheel 152 by which it is driven by the drive organ 14. The display 120 is hafted onto the pivot shank 151 so as to be rotationally mobile via a display pipe 1201. The display pipe 1201 comprises a display pipe wheel 1202 by which it is connected to a pinion on the drive mobile 150 via an intermediate wheel 16.

As previously indicated, due to the characteristics of the invention, the graphical representation of the Earth 120 that is visible through the aperture 130 is designed to represent the Earth as seen by an observer orbiting the Moon. Preferentially, the Earth phase display device 12 is configured so that the display 120 makes one turn in two hours. Furthermore, to indicate the phases of the Earth, the mask 122 is rotated by 6.1 degrees more per day than the display 120. A person skilled in the art can easily design trains with appropriate gear ratios.

In another exemplary embodiment of the invention, the display 120 and the mask 122 can be kinematically connected to an hour wheel connected to the hour hand. A person skilled in the art can also easily design a train with appropriate gear ratios.

It should be noted that, for the sake of concision of the application, the components of the horology movement known to the person skilled in the art are not described in this present text and do not appear in the figures.

Moreover, it should be noted that the embodiments and uses considered above have been described by way of non-limiting examples, and that other variants are therefore conceivable.

In particular, the mask 122 and the display 120 can be moved by two separate electric motors designed to be powered with energy from a shared or separate electricity source.

Moreover, in the alternative, the mask 122 and the display 120 can be moved by the same drive organ formed by a barrel kinematically connected to a regulating organ.

1. A watch (10) comprising a dial (13) and a horology movement (11) comprising a device for displaying the Earth, wherein the device for displaying Earth phases (12) comprises a display (120) with two diametrically opposite graphical representations of the Earth (121) on either side of an axis of rotation of the display (120), the display (120) being arranged facing an aperture (130) made in the dial (13) and having a shape such that it is capable of masking one of the graphical representations of the Earth (121) when the display (120) is rotated; the Earth phase display device (12) further comprising a mask (122) rotated by a drive-organ (14) and inserted between the display (120), the display (120) and the mask (122) being driven at different rotational velocities.

2. The watch (10) according to claim 1, wherein the mask (122) is driven at a higher rotational velocity than the display (120).

3. The watch (10) according to claim 1, wherein the axis of rotation of the display (120) and that of the mask (122) are coincident.

4. The watch (10) according to claim 1, wherein the mask (122) has an opaque zone (1220), wherein part of the periphery forms two lobes in the form of a circular arc, arranged diametrically symmetrical to each other, the opaque zone (1220) being designed to partially or completely cover, and therefore mask, the graphical representation of the Earth (121) when the mask (122) is rotated.

5. The watch (10) according to claim 4, wherein the transparent and opaque zones are arranged diametrically opposite each other, so that when the mask (122) is in a first angular position, most of the transparent zone (1221) or all of said transparent zone (1221) is arranged facing the aperture (130), and that when the mask (122) is in a second angular position wherein the mask (122) is oriented at 180 degrees relative to the first angular position, the opaque zone (1220) is facing the entire aperture (130).

6. The watch (10) according to claim 1, wherein the mask (122) is fastened to a pivot shank (151) on a drive mobile (150) so as to rotate along with it via a mask pipe (1223), the drive mobile (150) comprising a drive wheel (152) by which it is driven by the drive organ (14), the display (120) being fastened to the pivot shank (151) so as to be rotationally mobile via a display pipe (1201), the display pipe (1201) comprising a display pipe wheel (1202) by which it is connected to a pinion on the drive mechanism (150) via an intermediate wheel (16).

7. The watch (10) according to claim 1, wherein the mask (122) and the display (120) are rotated by the same drive organ (14) formed by an electric motor designed to be powered with energy from a source of electricity.

8. The watch (10) according to claim 1, wherein the mask (122) and the display (120) are moved by the same drive organ (14) formed by a barrel kinematically connected to a regulating organ.

9. The watch (10) according to claim 1, wherein the mask (122) and the display (120) can be moved by two separate electric motors designed to be powered with energy from a shared or separate source of electricity.
